(19) United States
(12) Patent Application Publication
(10) Pub. No.: US 2025/0136480 A1
(43) Pub. Date: May 1, 2025

(54) HYBRID ZERO-GAP ELECTROLYZER FOR THE TREATMENT OF AMMONIA IN WASTE WATER AND THE PRODUCTION OF PURE HYDROGEN GAS

(71) Applicant: CURRENT WATER TECHNOLOGIES INC., Guelph (CA)

(72) Inventors: Markus INGELSSON, Milton (CA); Gene Shelp, Guelph (CA)

(73) Assignee: Current Water Technologies Inc., Guelph, ON (CA)

(21) Appl. No.: 18/692,152

(22) PCT Filed: Sep. 20, 2022
(86) PCT No.: PCT/CA2022/051393

§ 371 Date: Mar. 14, 2024

Related U.S. Application Data
(60) Provisional application No. 63/245,717, filed on Sep. 17, 2021.

(51) Int. Cl. C02F 1/461; C02F 1/42; C02F 1/467; C02F 1/66; C02F 101/16

(52) U.S. Cl. CPC C02F 1/46109; C02F 1/42; C02F 1/4674; C02F 1/66; C02F 2001/46142; C02F 2001/46166; C02F 2101/16; C02F 2201/46115; C02F 2201/46185

(57) ABSTRACT

An apparatus, system and method consists of an electrolytic cell designed for simultaneous removal of total aqueous ammonia in the anolyte and production of high purity hydrogen gas in an electrolyte-free cathodic compartment. The system is designed as a divided electrochemical cell, separated by a proton exchange membrane. The cathode side is of “zero-gap-design”, where a carbon-based catalytic material is hot-pressed onto the proton exchange membrane adjacent to a cathodic current collector. Ammonia is concentrated in a high concentration brine, which flows through a conduit that is positioned in between the dividing membrane and a metal anode. The pure, high concentration brine permits operation at high current densities without the formation of fouling layers. Protons released from the oxidation of ammonia are transported across the proton exchange membrane, where hydrogen evolution proceeds in a porous, catalyst coated cathode, and facilitates the production of significant amounts of hydrogen gas.

### TECHNICAL FIELD

The present disclosure relates to water treatment systems, and in particular to electrochemical water treatment systems for treatment of ammonia in waste water.

### BACKGROUND

Contamination of water bodies with ammonia has become a serious problem in many parts of the world. Ammonia originates from nutrients (often fertilizer) and the decomposition of biological material. In its protonated form (ammonium), ammonia is highly water soluble, and enters natural water bodies with ease. Once accumulated in lakes and other freshwater bodies, ammonia acts as a nutrient to promote algae growth, thus leading to eutrophication. This effect can be devastating to ecological systems, and is a human health hazard.

Ammonia is a contaminant of particular concern due to its toxicity to humans, and due to its ability to cause ecological damage. Agricultural regions tend to have particularly severe problems with ammonia due to leaching of fertilizer into natural water bodies, which promotes algae growth and affects the quality of potable ground water. Livestock farming also produces ammonia waste, which is of considerable concern if left untreated. Ammonia is also present in domestic waste water, which, by law, must be treated before discharge.

To date, the treatment of aqueous ammonia remains complicated, as conventional biological nitrification/denitrification systems are associated with large capital and operating expenditures. In addition, biological systems require large footprints and are typically only built at centralized waste water treatment plants. Therefore, the development of green, economical, and modular treatment systems is warranted.

To meet the ambitious greenhouse gas emissions targets stipulated by the Paris Climate Accord, global industries must transition towards reducing their carbon footprints. Conventional biological ammonia treatment systems are energy intensive and emit greenhouse gas emissions in the form of nitrous oxide; hence, they have a large carbon footprint. Conversely, it has been demonstrated that electrochemical water treatment systems do not produce nitrogenous greenhouse gas emissions-instead, they effectively convert ammonia into nitrogen gas (N_{2(g)}). In addition, electrochemical reactors produce hydrogen gas as a by-product, which can be utilized as a power to gas (P2G) energy storage system. Electrochemical systems are also highly capable of being integrated with renewable energy sources, such as wind and solar power, as they operate on direct current (DC) and require minimal auxiliary electrical infrastructure. Hence, the simultaneous treatment of ammonia-ridden waste water and the production of hydrogen gas has the potential to operate waste water treatment plants as energy storage facilities.

Electrolytic water treatment systems have been utilized for the treatment of a wide range of contaminants, including organics and inorganics. These systems operate by submerging metal electrodes directly into contaminated water, which functions as an electrolyte in the electrolytic cell. By applying a direct current to the electrodes, electrochemical reactions at the electrolyte-electrode interfaces drive the destruction and removal of aqueous pollutants directly, or indirectly by the production of chemical intermediates. Depending on the electrode material, strong oxidants like hydroxyl radicals, hydrogen peroxide, or chlorine are generated—which are capable of mineralizing organics to carbon dioxide. Alternatively, using a sacrificial electrode like iron or aluminum, metal coagulant is produced in-situ that destabilize organic/inorganic colloidal contaminants, causing them to precipitate. Most of these reactions take place at the positively polarized electrode, i.e. the anode. Contaminant removal may also proceed at the negatively polarized cathode; e.g., the conversion of nitrates/nitrites or organochlorinated substances to harmless species, which occurs through electrochemical reduction. However, these reactions are kinetically and thermodynamically unfavorable, as the most favorable cathodic reaction under normal operating conditions is the electrolytic splitting of water that produces hydrogen gas. The anode-electrolyte-cathode system is referred to herein as a “cell”.

In the conventional operation of electrochemical water treatment processes, the anode and cathode are placed in the same compartment, i.e., the reaction products and reactants are not separated by a membrane or diaphragm. Therefore, the cathodically produced hydrogen is mixed with gases produced by the anode, along with preexisting gases in the electrolyte. Due to the complexity of separating and isolating gaseous hydrogen, it is typically not conducted—and is instead vented to the atmosphere.

Waste waters used as electrolytes in conventional electrochemical systems often exhibit low conductivities, which increases the electrical resistivity within the cell. Due to this high resistivity, these reactors are often operated at low current densities (<200 A m⁻²), which limits the production rate of hydrogen. Conversely, operating with a high conductivity brine would significantly reduce the resistivity within the electrochemical cell, thus permitting the application of higher current densities. The evolution of hydrogen is directly proportional to the charge passed through the cell; hence, operating at higher current densities would permit greater hydrogen production rates.

The applied current is typically proportional to the contaminant concentration (i.e., more polluted waters require operation at a higher current). Conventional reactors are often designed to abate low concentrations of aqueous contaminants; hence, they typically operate at low current densities and produce little hydrogen, insufficient for P2G applications. In addition, conventional reactors are prone to experience electrochemical side reactions, such as anodic oxygen evolution, upon the application of higher current densities. Side reactions are problematic since they re-direct the current away from the desired reactions that are responsible for the abatement of aqueous contaminants. In addition, traditional electrochemical water treatment systems suffer from the precipitation of material on the electrodes, which is exacerbated during high current density operation.

In view of the foregoing, it is necessary to develop water treatment systems which address noted deficiencies in the prior art, including via use of reactors that are capable of operating at high current densities (>500 A m⁻²) for treating waste streams with high contaminant concentrations while producing significant amounts of green hydrogen-all while avoiding parasitic side reactions and preventing the precipitation of fouling layers on the electrodes.

### SUMMARY OF PARTICULAR EMBODIMENTS

It will be appreciated by those skilled in the art that other variations of the embodiments described below may also be practiced without departing from the scope of the invention. Further note, these embodiments, and other embodiments of the present invention will become more fully apparent from a review of the description and claims which follow.

In one embodiment, the present invention pertains to the electrochemical treatment of total aqueous ammonia (defined as ammonia+ammonium), and the simultaneous production, and capture, of high purity hydrogen gas. Electrochemical water treatment refers to the application of an electrical current to electrodes submerged in waste water to drive the destruction of aqueous contaminants. Apart from abating ammonia, in one embodiment, the present invention is designed to be used as a form of P2G electrolyzer, as it produces hydrogen gas as a usable by-product. P2G systems utilize energy to produce a chemical feedstock, which can be used for various purposes. The most common P2G system is producing gaseous hydrogen through water electrolysis, which has been identified as a viable energy storage solution for addressing the inherent intermittency of renewable energy generation.

Other particular embodiments of the present invention include a water treatment system which includes the following: an electrochemical reactor, i.e., an electrolytic cell, where a direct current—supplied by an external power supply—drives electrochemical reactions at the anode(s) and cathode(s). A proton exchange membrane (PEM), separates the anodic compartment from the cathode. In the anodic compartment, a catalyst coated electrode (usually a rectangular plate) is positioned parallel to the proton exchange membrane. The anode (also referred to as a “Dimensionally Stable Anode” or DSA), is a titanium plate with a metal oxide coating consisting of, but not limited to, RuO₂, IrO₂, PtO₂, SnO2 or a combination of these species. A flow conduit is positioned in between the DSA and the PEM, where the ammonia-ridden water is able to flow with low hydraulic resistance.

In one particular embodiment, there is described a waste water treatment apparatus comprising an at least one electrolytic cell, each cell having an anodic compartment comprising an anode and a cathodic compartment comprising a cathode; an at least one inlet for receiving a flow of waste water to be treated into the anodic compartment; an at least one proton exchange membrane disposed between the anodic compartment and the cathodic compartment; a catalyst coated electrode disposed within the anodic compartment and positioned parallel to the proton exchange membrane; an at least one fluid conduit disposed between the anode and the proton exchange membrane, the fluid conduit for permitting flow of treated through the anodic compartment; and an at least one outlet operatively connected to the anodic compartment, for receiving a flow of treated waste water; and at least one outlet operatively connected to the cathodic compartment for receiving a flow of produced hydrogen gas; and at least one outlet operatively connected to the cathodic compartment to drain liquid caustic byproduct. The apparatus functions to convert aqueous ammonia in the waste water into innocuous nitrogen gas in an electrolytic cell, while producing high purity hydrogen gas.

In another particular embodiment of the present invention, there is described a waste water treatment method for isolating ammonia from the waste water by transferring it to an anolyte containing a high concentration sodium chloride brine; whereas the particular embodiment described in the previous paragraph is for converting aqueous ammonia present in the brine into innocuous nitrogen gas in an electrolytic cell, while producing high purity hydrogen gas; and producing chlorine which forms hypochlorite upon contact with water; and converting free ammonia within the water into nitrogen gas by hypochlorite in the bulk electrolyte; wherein the high concentration of sodium chloride lowers ohmic resistance within the cell, thereby permitting cell operation at high current densities.

### BRIEF DESCRIPTION OF THE DRAWINGS

In the drawings, preferred embodiments of the invention are illustrated by way of example. It is to be expressly understood that the drawings are only for the purpose of illustration and as an aid to understanding and are not intended as a definition of the limits of the invention. The embodiments herein will be understood from the following description with reference to the drawings, in which:

FIG. 1 is a cross sectional schematic drawing of the embodiment of a reactor, in accordance with one embodiment of the present disclosure. The thickness of each layer is not drawn to scale;

FIG. 2 is a planar schematic drawing which illustrates how the anolyte flow channels are configured within the reactor, in accordance with one embodiment of the present disclosure. The hydrogen exhaust conduits are also displayed, in accordance with one embodiment of the present disclosure; and

FIG. 3 is an exploded view of a single cell stack, in accordance with one embodiment of the present disclosure, including all layers constituting a cell.

### DETAILED DESCRIPTION OF EXAMPLE EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

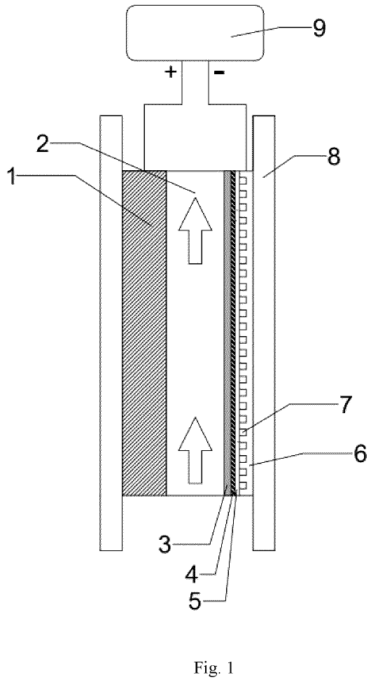

Referring to the drawings, a conceptual representation of the embodiments of an electrochemical reactor is shown in FIG. 1, in accordance with one embodiment of the present invention. In the embodiment shown, the ammonia-concentrated brine flows through a flow conduit (2), which is located between the DSA (1) and the PEM (3). The thickness of this flow channel is between 0.5-10 mm to permit a relatively high hydraulic conductivity. Preferably, a small separation is incorporated to minimize the voltage drop in the electrolyte, and to reduce the overall thickness of the stack. The PEM is comprised of a perfluorinated material, e.g. Nafion®, or any other suitable proton conductive material whose thickness is between 25-250 μm. On the cathodic side of the PEM, the platinum coated carbon catalyst layer (4) may be deposited onto the PEM, which is designed to facilitate the hydrogen gas evolution reaction (HER). Adjacent to the platinum/carbon catalyst, a hydrophobic gas diffusion layer (carbon cloth) can be placed (5), which allows the transport of the produced hydrogen. The PEM, catalyst layer, and gas diffusion electrode together make up the membrane electrode assembly (MEA). A current collector (6) with channels for capturing hydrogen gas (7) is positioned adjacent of the cathode. The material of this layer can be, but is not limited to, high density graphite, titanium, or stainless steel.

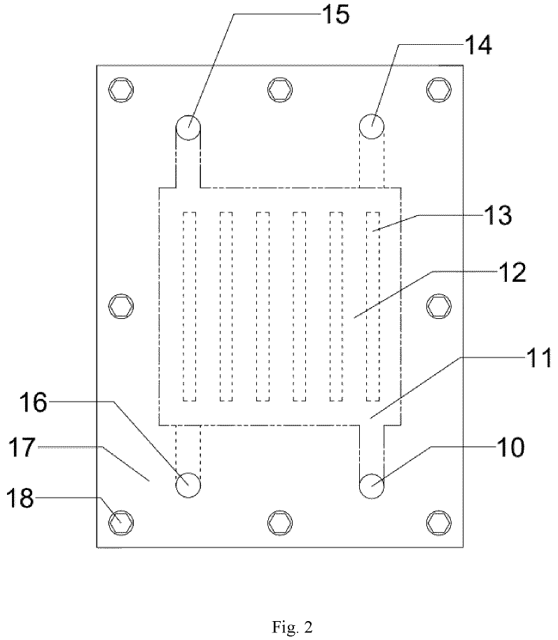

A planar view of the flow channels within each cell is shown in FIG. 2. In one particular embodiment shown and described herein, the anolyte enters the cell (10), and subsequently flows into the main embodiment (11), where reactions 1-3 take place. Once in the main embodiment, the anolyte flows through designated flow channels (12), which are created by dividers (13) to enhance fluid distribution within the cell, to avoid areas of fluid stagnation, to avoid turbulent flow, and to provide structural integrity to the reactor. Thereafter, the anolyte exits the reactor on the opposing side of the flow field (15). On the opposite side of the PEM, produced hydrogen is exhausted through a designated conduit (14).

The components in the embodiment mentioned so far represent a cell. Multiple cells can be sequenced, and electrically connected in series, or in parallel, to create a stack. When connected electrically in series, bipolar electrodes are used, whereas monopolar plates are used in a parallel stack configuration. Hence, for the construction of bipolar plates, the cathodic current collector would be adjacent to a DSA, and the sequence of components (1-6) would be repeated. No external electrical connections are required for the bipolar plates, which are polarized under the electrical field created between the monopolar electrodes at either end of the stack.

With a monopolar electrode configuration, each electrode has an electrical connection; hence, each electrode has the same electrical polarization on both sides. Therefore, each adjacent cell in the stack has a reverse configuration, i.e., the sequencing of components 1-5 is flipped. For example, the cathodic current collector in FIG. 1 (6) would act as a cathodic current collector on its opposite side, followed by an MEA, a brine flow channel, and a DSA. This alternating pattern would continue throughout the entirety of the stack. A full stack can include, but is not limited to, 20 cells.

Both electrical configurations are theoretically equally thermodynamically efficient; however, the bipolar configuration (electrical connections in series) is more practical since a lower amperage is applied across the entire stack. Lower amperage permits using less complicated electrical infrastructure (e.g., downsizing busbars and electrical cables).

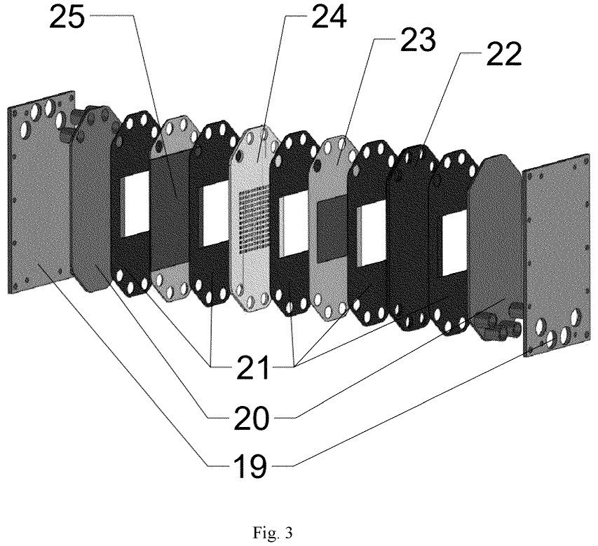

Still referring to FIG. 3, at both ends of the stack, end plates made of, but not limited to, stainless steel (17) are used to hold the reactor together. In one embodiment, threaded rods and nuts (18), centered around the perimeter of the cell, are used to compress the cell. The threaded rods shall be enveloped by a non-conductive sleeve to avoid electrical short connections within the stack. Of course, other suitable securement means (other than threaded rods and nuts) may be employed.

An exploded view of a cell, including end plates (19, 20), is shown in FIG. 3. In this configuration, plastic endplates (20) with plumbing connections protruding through the steel plates are positioned as the penultimate layer. The plastic endplates can be made of any chemically resistant polymer, such as, but not limited to, polyethylene or polypropylene. Chemically resistant gaskets (21) are placed in between each layer in the reactor, which provides a water and gas tight seal upon compression. The gasket material can be Viton®, PTFE, or any other material with high resistivity to pH, chlorine, hypochlorite, and ammonia. In addition, the cathode current collector (22), the MEA (23), the anolyte flow conduit housing (24), and the DSA (25) are depicted in FIG. 3.

While the cathodic compartment is “dry”, the flow pattern has two outlets, one at either end of the cell (top and bottom). Due to some water carry-over through the membrane during operation, water must be removed to avoid its accumulation in the gas flow channels, which are intended for capturing hydrogen. Therefore, a drainage channel (16) is incorporated to permit water to exit the reactor by gravity. Due to the hydrogen evolution reaction (HER), the water in the catholyte is alkaline, and can be used to neutralize the pH in the anolyte. In addition, this design allows for clean water or acid to be circulated through the cathode flow channels, which may be required to clean the reactor intermittently.

In the cathodic compartment, the PEM can be coated with a catalyst layer, which can be, but is not limited to, platinum on carbon with a polymer binder, at loadings between 0.1-10 mg of platinum per cm². The polymer binder can be, but is not limited to, Nafion®. The coating is deposited onto the membrane by painting, spraying, or using a film applicator. Alternatively, the catalyst can be prepared separately, and deposited onto the PEM using the decal transfer technique. A hydrophobic carbon cloth gas diffusion layer (GDL) may be placed on top of the catalyst, where produced hydrogen gas is transported away from the cathode. In order to enhance electrical conductivity, the GDL can be hot-pressed onto the catalyst layer on the cathodic side of the PEM. A bipolar current collector, made of, but not limited to, graphitic carbon, stainless steel, or titanium with built-in flow channels, is in contact with the GDL, which provides an electrical connection while permitting hydrogen gas to escape through external plumbing.

The hydrogen gas exiting the reactor is of high purity, but may still contain impurities such as water vapor. Therefore, post-processing apparatuses may be installed such as condensers or desiccators. Once purified, hydrogen can be stored in high pressure vessels, a solid-state hydride material, or any other hydrogen storage systems. In addition, the hydrogen is of sufficient purity to be used directly in a fuel cell or as a chemical feedstock in an industrial process. The present invention is designed to operate at relatively high pressures, which may be controlled by a back pressure regulator. Therefore, the exhaust gas pressure can be regulated depending on the downstream application.

The invention disclosed herein can be integrated into an ammonia-concentrating circuit. In this system, ammonia is separated from waste water by a zeolite ion exchange column or a stripper/scrubber process. The ion exchange column (or ion exchange media) is regenerated using a closed-circuit concentrated NaCl brine (>50 g L⁻¹), which captures and concentrates the ammonia. Similarly, a stripper/scrubber system effectively isolates ammonia, and concentrates it in a NaCl brine.

Once concentrated in the brine, ammonia is converted into nitrogen gas in the electrochemical reactor. The DSA favors the production of chlorine (Cl₂), which forms hypochlorite (HClO⁻¹) upon contact with water (reactions 1 and 2, respectively). Ammonia is subsequently oxidized to N_{2(g)} by HClO in the bulk electrolyte (reaction 3); hence, chloride ions (Cl⁻) are required for effective conversion of NH₃ to N_{2(g)}. Those skilled in the art will recognize that the high concentration of NaCl lowers the ohmic resistance within the cell, and permits operating at high current densities (>500 A m⁻²). The ammonia-depleted brine exiting the reactor is subsequently recirculated through the ion-exchange column or stripper/scrubber system to continue the process. Hence, there is little/no loss of brine over the operating cycle.

$$2 {Cl}^{-} \to {Cl}_{2} + 2 {e}^{-} \qquad [ 1 ]$$

$${Cl}_{2} + {H}_{2} O \to HClO + {H}^{+} + {Cl}^{-} \qquad [ 2 ]$$

$$2 {NH}_{4}^{+} + HClO \to {{N}_{2} + {H}_{2} O + 7 {H}^{+} + Cl}^{-} + 4 {e}^{-} \qquad [ 3 ]$$

Simultaneously, protons are able to migrate through the PEM to the cathode, where they react to form H_{2(g)} (reaction 4). Due to the nature of reactions 1 and 4, a minimum cell potential of 2.19 V is required to drive these reactions. The operating cell voltage will increase as the current density is increased, but should not exceed 5 V to avoid premature degradation of the anodic and cathodic catalyst layers.

$$2 {H}^{+} + 2 {e}^{-} \to 2 {H}_{2 ( g )} \qquad [ 4 ]$$

The anolyte is kept clean from other species that may contaminate the reactor since only ammonia is isolated from the waste water. Therefore, the problem of fouling layer formation within the reactor is avoided. In addition, the nature of the high hypochlorite concentration mineralizes any organics, thus eliminating the possibility of biofouling within the system. In the case of other contaminants of concern in the source water, e.g., alkaline earth metals that contribute to hardness, additional treatment systems may need to be implemented.

Since the concentration of the NaCl brine is kept high, the availability of Cl⁻¹ at the DSA electrode(s) avoids mass transfer limitations that may incur for the evolution of Cl₂ (reaction 1) at high current densities. When operating with a cell potential above 2.19 V, there is little possibility of side reactions occurring due to the thermodynamic and kinetic favorability of reaction 1; hence, high current efficiencies for Cl₂ evolution and ammonia oxidation are achieved at high current densities.

In waste waters where chloride concentrations are already high (e.g., seawater) the ammonia-ridden waste can be directly injected into the reactor without any concentrating steps. However, certain chemical species, like calcium and magnesium, may have to be removed upstream of the reactor to avoid fouling by hardness scales.

Those skilled in the art will recognize that the present invention is distinguished from ammonia electrolysis, which electrochemically converts ammonia to N_{2(g)} without intermediary steps. The process exhibits low energy intensity because the reactions occur at a cell potential of 0.057 V. However, the process requires a high operating pH (pH >9) because ammonia must be present in its unprotonated form; hence, dosing with a base upstream of the reactor is essential. In addition, this reaction occurs at the electrode surface; therefore, the reaction rate (i.e. the current) is limited to the rate of mass transport of ammonia from the bulk electrolyte to the electrode surface. Since ammonia is non-ionic, there is no electrophoretic effect driving the migration of ammonia to the electrode, which further limits the applied current density. The present invention avoids these mass transfer limitations, as Cl is in high availability and migrates to the positively charged anode electrophoretically.

In one particular embodiment, the system, apparatus and method of the present invention involves operation at a moderate to high current density (>200 A m⁻²), and concentrates the target pollutant in a high concentration brine. In addition, the selected current density facilitates the production of material amounts of hydrogen. Further, the system and apparatus of the present invention is not prone to clogging since the present invention does not permit ammonia-ridden waste water to flow on the outer side of the anode and the PEM. In prior art systems, a porous anode catalyst layer is deposited onto the PEM, where the electrochemical reactions occur, while simultaneously permitting the migration of hydrogen protons from the anolyte to evolve hydrogen at the cathode. Consequently, the ammonia-ridden waste water flows on the outer side of the anode and the PEM. However, the porous nature of the anode makes it prone to clogging by the precipitation of dissolved or suspended solids, hence reducing process performance.

The system, apparatus and method of the present invention utilizes an anode configuration, which is designed to evolve Cl₂ rather than directly oxidizing organics at the electrode. In addition, the present invention permits operation at high current densities and high anolyte flowrates, while preventing the formation of fouling layers, which is also aided by high hydrodynamic shear on the electrode surface from the anolyte flow. These effects are accomplished by flowing the anolyte in between the anode and the PEM. In addition, isolating the contaminant (ammonia) in the brine eliminates the issue of hardness/silica scaling within the reactor, which would be encountered when treating waste water directly. Further still, the present invention has the advantage that waste water is, under most circumstances, never passed through the electrochemical reactor, thus avoiding any problems related to clogging, fouling, and low conductivities.

Particular embodiments of the present invention include a system and apparatus consisting of an electrolytic cell designed for simultaneous removal of total aqueous ammonia in the anolyte and production of high purity hydrogen gas in an electrolyte-free cathodic compartment. The system is designed as a divided electrochemical cell, separated by a proton exchange membrane (PEM). The cathode side is of “zero-gap-design”, where a carbon-based catalytic material is hot-pressed onto the proton exchange membrane adjacent to a cathodic current collector. Ammonia is concentrated in a high concentration brine, which flows through a conduit that is positioned in between the dividing membrane and a metal anode, thus permitting high hydraulic conductivity. The pure, high concentration brine permits operation at high current densities (>500 A m⁻²) without the formation of fouling layers. Protons released from the oxidation of ammonia are transported across the proton exchange membrane, where hydrogen evolution proceeds in a porous, catalyst coated cathode. Hydrogen gas is collected in a flow field incorporated into the cathodic current collector, and subsequently exhausted into a gas purification system outside of the electrolyzer. The operation with a relatively high current density facilitates the production of significant amounts of hydrogen gas suitable for powering machinery or being used as chemical feedstock.

Other particular embodiments of the present invention include an electrochemical reactor, i.e., an electrolytic cell, where a direct current (supplied by an external power supply) drives electrochemical reactions at the anode(s) and cathode(s). A proton exchange membrane (PEM), separates the anodic compartment from the cathode. In the anodic compartment, a catalyst coated electrode (usually a rectangular plate) is positioned parallel to the proton exchange membrane. The anode (also referred to as a “Dimensionally Stable Anode” or DSA), is a titanium plate with a metal oxide coating consisting of, but not limited to, RuO₂, IrO₂, PtO₂, SnO2 or a combination of these species. A flow conduit is positioned in between the DSA and the PEM, where the ammonia-ridden water is able to flow with low hydraulic resistance.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. A waste water treatment apparatus comprising:
a) an at least one electrolytic cell, each cell having an anodic compartment comprising an anode and a cathodic compartment comprising a cathode;
b) an at least one inlet for receiving a flow of waste containing ammonia concentrated in a brine, to be treated into the anodic compartment;
c) an at least one proton exchange membrane disposed between the anodic compartment and the cathodic compartment;
d) a catalyst coated electrode disposed within the anodic compartment and positioned parallel to the proton exchange membrane;
e) an at least one fluid conduit disposed between the anode and the proton exchange membrane, the fluid conduit for permitting flow of ammonia ridden brine through the anodic compartment;
f) an at least one outlet operatively connected to the cathode, for receiving a flow of produced hydrogen; and
g) at least one outlet operatively connected to the cathode for draining caustic liquid byproduct.

2. The waste water treatment apparatus of claim 1, wherein the proton exchange membrane within the cathodic compartment is coated with a catalyst layer.

3. The waste water treatment apparatus of claim 2, wherein the catalyst layer is a coating of platinum on carbon composition.

4. The waste water treatment apparatus of claim 3, wherein the catalyst layer further comprises a polymer binder for binding the platinum on carbon composition to the proton exchange membrane within the cathodic compartment.

5. The waste water treatment apparatus of claim 1, further comprising a gas diffusion layer is disposed on top of the catalyst layer, the gas diffusion layer for facilitating transmission of hydrogen gas away from the cathode.

6. The apparatus of claim 1, further comprising a current collector having in inlet and an outlet, the current collector for permitting escape of hydrogen gas from the apparatus.

7. The apparatus of claim 6, wherein the gas diffusion layer is in operative communication with the current collector.

8. The apparatus of claim 1, wherein the anode comprises a titanium plate with a coating of metal oxide.

9. The apparatus of claim 8, wherein the metal oxide is selected from the group consisting of RuO₂, IrO₂, PtO₂, and SnO2.

10. The apparatus of claim 1, wherein the at least one fluid conduit constitutes a plurality of flow channels for enhancing fluid distribution within the cell.

11. The apparatus of claim 1, comprising a plurality of cells operatively connected to each other.

12. A waste water treatment method for converting aqueous ammonia into innocuous nitrogen gas in an electrolytic cell, while producing high purity hydrogen gas, comprising the steps of:
a) Isolating ammonia from the waste water in an anolyte containing a high concentration sodium chloride brine;
b) Producing chlorine which forms hypochlorite upon contact with water;
c) Converting free ammonia within the water into nitrogen gas by hypochlorite in the bulk electrolyte, or through direct oxidation at the anode surface,
wherein the high concentration of sodium chloride lowers ohmic resistance within the cell, thereby permitting cell operation at high current densities

13. The method of claim 12, wherein ammonia is separated from waste water using ion exchange media in fluid communication with the cell.

14. The method of claim 13, further comprising the step of exhausting the brine from the cell and subsequently recirculating the brine through the ion exchange media and back into the cell.

15. The method of claim 12, using the electrolytic cell of claim 1.

16. The method of claim 12, wherein the method operates between 0° C. and 90° C.

17. The method of claim 12, wherein the method operates at a pressure between 1-1,000 psi.

18. The method of claim 12, wherein the method operates at current densities of >500 A m⁻²

19. The method of claim 12, further comprising the step of applying between 2 to 5 volts to the cell.

20. The method of claim 12, further comprising the step of neutralizing the pH of the anolyte to avoid chlorine gas evolution, and to maintain high conversion efficiency of ammonia.
